(19) United States
(12) Patent Application Publication
(10) Pub. No.: US 2026/0161881 A1
(43) Pub. Date: Jun. 11, 2026

(54) DOCUMENT PROCESSING METHOD AND APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Ziqing XU, Beijing (CN); Jianfeng NI, Beijing (CN)

(21) Appl. No.: 19/123,028

(22) PCT Filed: Sep. 15, 2023
(86) PCT No.: PCT/CN2023/119195

§ 371 Date: Apr. 21, 2025

(30) Foreign Application Priority Data
Oct. 31, 2022 (CN) 202211353557.4

(51) Int. Cl. G06F 40/166

(52) U.S. Cl. CPC G06F 40/166

(57) ABSTRACT

The present disclosure provides a document processing method and apparatus, an electronic device, a storage medium, and a program product. The method comprises: determining a target content block in a target document, where the target content block has a reference relationship with an associated content block in an associated document; obtaining a first position range of the target content block in the target document; obtaining, in response to receiving an operation of adjusting a boundary range of the target content block, a second position range of the boundary range adjusted target content block in the target document; and displaying, in the target document based on the second position range, the boundary range adjusted target content block.

The present application claims priority to Chinese Patent Application No. 202211353557.4, filed with the China National Intellectual Property Administration on Oct. 31, 2022 and entitled “DOCUMENT PROCESSING METHOD AND APPARATUS, ELECTRONIC DEVICE, STORAGE MEDIUM, AND PROGRAM PRODUCT”, which is incorporated herein by reference in its entirety.

### TECHNICAL FIELD

The present disclosure relates to the field of computer technologies, and in particular, to a document processing method and apparatus, an electronic device, a storage medium, and a program product.

### BACKGROUND

A cloud document can meet requirements of flexible sharing of users and multi-person collaboration on a document. Content in another document is often referenced in the cloud document. For example, during editing of a host document, some content in a source document may be referenced into the host document.

When some content of the source document is referenced into the host document, a reference region where the content is located is locked, and a boundary of the reference region cannot be adjusted.

### SUMMARY

In view of the above, an object of the present disclosure is to provide a document processing method and apparatus, an electronic device, a storage medium, and a program product.

Based on the above object, the present disclosure provides a document processing method, including:
determining a target content block in a target document, wherein the target content block has a reference relationship with an associated content block in an associated document;
obtaining a first position range of the target content block in the target document;
in response to receiving an operation of adjusting a boundary range of the target content block, obtaining a second position range of the boundary range adjusted target content block in the target document; and
displaying, in the target document, the boundary range adjusted target content block based on the second position range.

The present disclosure further provides a document processing apparatus, including:
a determining module configured to determine a target content block in a target document, wherein the target content block has a reference relationship with an associated content block in an associated document;
a first obtaining module configured to obtain a first position range of the target content block in the target document;
a second obtaining module configured to, in response to receiving an operation of adjusting a boundary range of the target content block, obtain a second position range of the boundary range adjusted target content block in the target document; and
a display module configured to display, in the target document, the boundary range adjusted target content block based on the second position range.

The present disclosure further provides an electronic device, including a memory, a processor, and a computer program stored in the memory and executable on the processor, where the processor, when executing the program, implements the method according to any of the above.

The present disclosure further provides a non-transitory computer-readable storage medium storing computer instructions, where the computer instructions are configured to cause the computer to execute the method according to any of the above.

The present disclosure further provides a computer program product including computer program instructions that, when running on a computer, cause the computer to perform the method according to any of the above.

It can be seen from the above that in the document processing method and apparatus, the electronic device, the storage medium, and the program product provided in the present disclosure, when a boundary range of a target content block is adjusted, a second position range of the boundary range adjusted target content block in the target document is determined based on a first position range of the target content block in the target document and the adjusted boundary range, and then the target content block is displayed in the target document based on the second position range, to implement adjustment and display of the boundary range of the target content block, thereby improving flexibility and scalability in document referencing.

### BRIEF DESCRIPTION OF THE DRAWINGS

In order to more clearly describe the technical solutions in the present disclosure or related technologies, the following briefly describes the accompanying drawings for describing the embodiments or related technologies. It is clear that the accompanying drawings in the following description show merely some embodiments of the present disclosure, and a person of ordinary skill in the art may still derive other drawings from these accompanying drawings without creative efforts.

FIG. 1 is a schematic diagram of an access architecture of a document according to embodiments of the present disclosure;

FIG. 2 is a schematic diagram of a hardware structure of an exemplary electronic device according to embodiments of the present disclosure;

FIG. 3 is a schematic diagram of a source document or a host document according to embodiments of the present disclosure;

FIG. 4 is a flowchart of a document processing method according to embodiments of the present disclosure;

FIG. 5 is a schematic diagram of an exemplary page according to embodiments of the present disclosure;

FIG. 6 is a flowchart of a method for obtaining a first position range according to embodiments of the present disclosure;

FIG. 7 is a flowchart of a method for obtaining a second position range according to embodiments of the present disclosure;

FIG. 8a is a schematic diagram of a structure of a target content block according to embodiments of the present disclosure;

FIG. 8b is a schematic diagram of another structure of the target content block according to embodiments of the present disclosure;

FIG. 8c is a schematic diagram of another structure of the target content block according to embodiments of the present disclosure;

FIG. 8d is a schematic diagram of another structure of the target content block according to embodiments of the present disclosure;

FIG. 9 is another flowchart of the method for obtaining the second position range according to embodiments of the present disclosure; and

FIG. 10 is a schematic diagram of a structure of a document processing apparatus according to embodiments of the present disclosure.

### DETAILED DESCRIPTION

To make the objectives, technical solutions, and advantages of the present disclosure clearer, the present disclosure is further described in detail below with reference to specific embodiments and the accompanying drawings.

It should be noted that, unless otherwise defined, the technical terms or scientific terms used in the embodiments of the present disclosure shall have the ordinary meanings understood by persons skilled in the art to which the present disclosure belongs. The “first”, “second”, and similar words used in the embodiments of the present disclosure do not indicate any order, quantity, or importance, but are used to distinguish different components. The words such as “include” or “include” mean that an element or object preceding the word covers an element or object listed after the word and equivalents thereof, but do not exclude other elements or objects. The words such as “connect” or “connect” are not limited to physical or mechanical connections, but may include electrical connections, whether direct or indirect. The words such as “upper”, “lower”, “left”, and “right” are only used to indicate relative position relationships, and when the absolute position of the described object changes, the relative position relationships may also change accordingly.

At present, in a multi-person collaboration mode of cloud documents, there is often a scenario where documents reference each other. Content of different parts in a source document may be referenced by one or more different documents. The referenced content is stored in the source document in the form of a referenced block, and the content referenced into a host document is also stored in the form of a referenced block. In addition, there is a case of overlap reference in the referenced blocks in the source document. For example, in the source document a, blocks 1, 2, 3, 4, and 5, after a user Xiaohua references the blocks 1 to 5 into a document b, the user Xiaohua references the blocks 3 to 4 into a document c.

However, in a model of overlap reference and multi-person collaboration, an existing technology cannot adjust an upper and lower boundaries of a reference region, resulting in poor flexibility and low scalability of the reference region.

In view of this, embodiments of the present disclosure provide a document processing method and apparatus, an electronic device, a storage medium, and a program product. The method includes: determining a target content block in a target document, the target content block being in a reference relationship with a linked content block in a linked document; obtaining a first position range of the target content block in the target document; in response to an adjustment of a boundary range of the target content block, obtaining a second position range of the boundary range adjusted target content block in the target document; and displaying, in the target document based on the second position range, the boundary range adjusted target content block. In these embodiments, when the boundary range of the target content block is adjusted, the second position range of the boundary range adjusted target content block in the target document is determined based on the first position range of the target content block in the target document and the adjusted boundary range, and then the target content block is displayed in the target document based on the second position range, to implement adjustment and display of the boundary range of the target content block, thereby improving flexibility and scalability in document referencing.

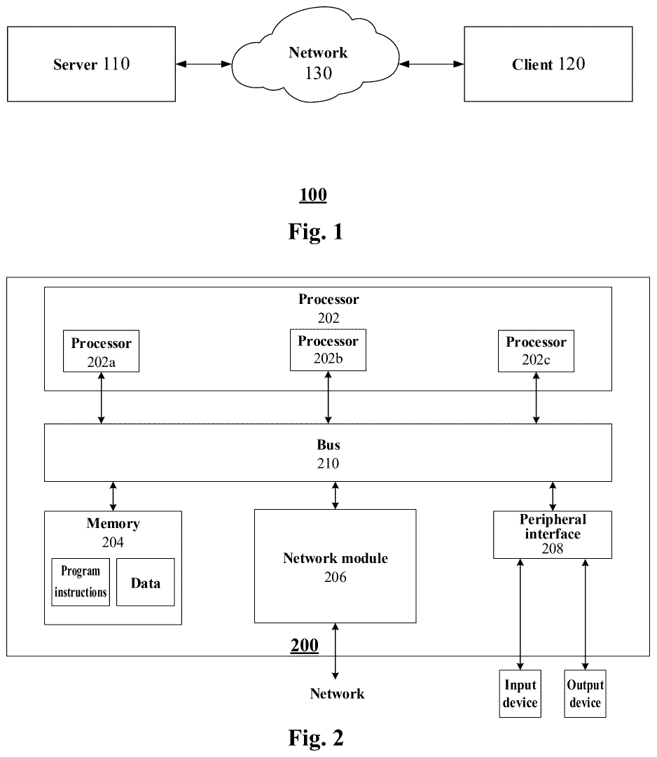

FIG. 1 is a schematic diagram of an access architecture of a document according to embodiments of the present disclosure. With reference to FIG. 1, an access architecture 100 of the document may include a server 110, a terminal 120, and a network 130 that provides a communication link. The server 110 and the terminal 120 may be connected through a wired or wireless network 130. The server 110 may be an independent physical server, or a server cluster or distributed system composed of a plurality of physical servers, or a cloud server that provides basic cloud computing services such as cloud service, cloud database, cloud computing, cloud function, cloud storage, network service, cloud communication, middleware service, and the like.

The terminal 120 may be implemented by hardware or software. For example, when the terminal 120 is implemented by hardware, it may be various electronic devices with a display screen and supporting page display, including but not limited to a smart phone, a tablet computer, an e-book reader, a laptop portable computer, a desktop computer, and the like. When the terminal 120 is implemented by software, it may be installed in the above-listed electronic devices; it can be implemented as multiple software or software modules (for example, software or software modules used to provide distributed services), or it can be implemented as a single software or software module, which is not specifically limited here.

It should be noted that the document processing method provided in the embodiments of the present application may be performed by the terminal 120 or by the server 110. It should be understood that the number of terminals, networks, and servers in FIG. 1 is only schematic, and is not intended to limit them. According to implementation requirements, there may be any number of terminals, networks, and servers.

FIG. 2 is a schematic diagram of a hardware structure of an exemplary electronic device 200 according to embodiments of the present disclosure. The electronic device includes a memory, a processor, and a computer program stored in the memory and executable on the processor, where the processor, when executing the program, implements the method according to any of the above embodiments.

As shown in FIG. 2, the electronic device 200 may include: a processor 202, a memory 204, a network module 206, a peripheral interface 208, and a bus 210. The processor 202, the memory 204, the network module 206, and the peripheral interface 208 are connected to each other through the bus 210 for communication inside the electronic device 200.

The processor 202 may be a central processing unit (CPU), a graphics processor, a neural network processor (NPU), a microcontroller (MCU), a programmable logic device, a digital signal processor (DSP), an application-specific integrated circuit (ASIC), or one or more integrated circuits. The processor 202 may be configured to perform a function related to the technology described in the present disclosure. In some embodiments, the processor 202 may further include a plurality of processors integrated into a single logical component. For example, as shown in FIG. 2, the processor 202 may include a plurality of processors 202a, 202b, and 202c.

The memory 204 may be configured to store data (for example, instructions, computer code, and the like). As shown in FIG. 2, data stored in the memory 204 may include program instructions (for example, program instructions for implementing the document access method according to embodiments of the present disclosure) and data to be processed (for example, the memory may store configuration files of other modules and the like). The processor 202 may also access the program instructions and data stored in the memory 204, and execute the program instructions to operate on the data to be processed. The memory 204 may include a volatile storage device or a non-volatile storage device. In some embodiments, the memory 204 may include a random access memory (RAM), a read-only memory (ROM), an optical disc, a magnetic disk, a hard disk, a solid-state drive (SSD), a flash memory, a memory stick, and the like.

The network module 206 may be configured to provide, for the electronic device 200, communication with other external devices through a network. The network may be any wired or wireless network capable of transmitting and receiving data. For example, the network may be a wired network, a local wireless network (for example, Bluetooth, Wi-Fi, near field communication (NFC), and the like), a cellular network, the Internet, or a combination thereof. It can be understood that the type of the network is not limited to the foregoing specific examples. In some embodiments, the network module 306 may include any combination of any number of network interface controllers (NICs), radio frequency modules, transceivers, modems, routers, gateways, adapters, cellular network chips, and the like.

The peripheral interface 208 may be configured to connect the electronic device 200 to one or more peripheral devices, to implement information input and output. For example, the peripheral devices may include input devices such as a keyboard, a mouse, a touchpad, a touchscreen, a microphone, and various sensors, and output devices such as a display, a speaker, a vibrator, and an indicator light.

The bus 210 may be configured to transmit information between various components (for example, the processor 202, the memory 204, the network module 206, and the peripheral interface 208) of the electronic device 200, such as an internal bus (for example, a processor-memory bus), an external bus (a USB port, a PCI-E bus), and the like.

It should be noted that although the architecture of the electronic device 200 shown above shows only the processor 202, the memory 204, the network module 206, the peripheral interface 208, and the bus 210, in an actual implementation, the architecture of the electronic device 200 may further include other components necessary for normal operation. In addition, a person skilled in the art can understand that the architecture of the above electronic device 200 may also include only components necessary for implementing the solution of the embodiments of the present disclosure, and does not necessarily include all the components shown in the figure.

A user userA may upload a source document documentA to a cloud, and the user userA is a document owner userA of the source document documentA. The document owner userA may set access permission to the source document documentA for a visitor. For example, the access permission may include a read permission or an edit permission. The read permission indicates that the user can access and read the content of the source document documentA, but cannot perform any operation on the source document documentA, such as editing, commenting, and the like. The edit permission indicates that the content of the source document documentA can be accessed and read, and an edit operation, such as modification, addition, and removal, can be performed on the content of the source document documentA. It should be understood that the document owner userA may directly set the access permission of a single user. For example, the access permission of a certain user is directly set to the read permission or the edit permission. Alternatively, the access permission of a type of users may be set in batch. For example, an access permission of a certain user set (for example, a group, a department, and the like) is set to the read permission or the edit permission, and the access permission of all collaborators under the set is the read permission or the edit permission.

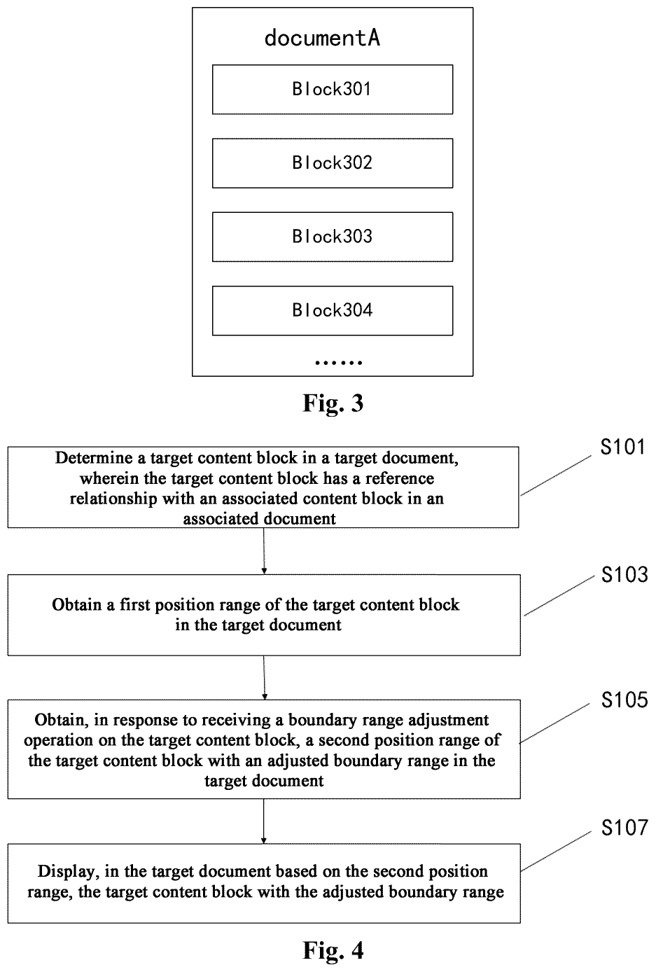

Referring to FIG. 3, FIG. 3 is a schematic diagram of a source document or a host document according to embodiments of the present disclosure. When the source document shown in FIG. 3 is a source document, the source document documentA includes content blocks Block301, Block302, Block303, Block304, . . . , where the content blocks Block302 and Block303 are referenced by another host document documentB; and when access permission set for the host document documentB includes permission allowing the source document to be edited, edited content of the content blocks Block302 and Block303 in the source document documentA is updated to the host document documentB. When the host document shown in FIG. 3 is a host document, the host document documentA includes content blocks Block301, Block302, Block303, Block304, . . . , where the content blocks Block302 and Block303 are referenced from another source document documentB; and when access permission set for the source document documentB includes permission allowing the host document to be edited, edited content of the content blocks Block302 and Block303 in the host document documentA is updated to the source document documentB.

FIG. 4 is a flowchart of a document processing method according to embodiments of the present disclosure. As shown in FIG. 4, the document processing method includes the following steps.
Step S101: Determine a target content block in a target document, wherein the target content block has a reference relationship with an associated content block in an associated document.

In these embodiments, after a referencer constructs a host document documentB, to reference content of a source document documentA, all or part of the content of the source document may be used as reference content and divided into one or more referenced blocks for referencing into the host document, so that the host document documentB establishes a reference relationship with the source document documentA.

In the source document documentA, content may be divided into a plurality of blocks (blocks), and the host document documentB may select one or more referenced blocks from the blocks as reference content during referencing.

In these embodiments, the user may perform an operation such as mouse hovering or clicking on a position of the target content block Block302 in the target document documentA. In response to the operation, the content block Block302 may be highlighted (for example, displayed in high brightness) and determined as the target content block.

In these embodiments, when the target document is the source document documentA and the linked document is the host document documentB, the linked content block (namely, the content block Block302′) references the target content block (namely, the content block Block302) in the target document (namely, the source document documentA). Alternatively, when the target document is the host document documentB and the linked document is the source document documentA, the target content block (namely, the content block Block302′) references the linked content block (namely, the content block Block302) in the linked document (namely, the source document documentA). This is not limited in these embodiments.

In order to facilitate understanding of the technical solutions of the present disclosure, in the embodiments of the present disclosure, the source document documentA is used as the target document, the host document documentB is used as the linked document, the content block Block302 in the source document documentA is used as the target content block, and the content formed after the content block Block302 is referenced into the host document documentB is used as the linked content block Block302′, to describe the technical solutions described in the present disclosure.
Step S102: Obtain a first position range of the target content block in the target document.

In some embodiments, when content included in the target content block is created in the target document, a position range stored in the target document by the target content block may be directly generated. For example, a horizontal coordinate range or a vertical coordinate range of the target content block in the target document (for example, when words, pictures, and the like in the target document are stored and displayed vertically) may be recorded as the first position range of the target content block in the target document. Alternatively, a node position of the target content block in the target document may be recorded as the first position range of the target content block in the target document. This is not limited in these embodiments.
Step S103: In response to receiving a boundary range adjustment operation for the target content block, obtain a second position range of the boundary range adjusted target content block in the target document.

In these embodiments, when a boundary range of the target content block is adjusted, for example, a reference range of the target content block is increased or decreased, based on the first position range of the target content block before the boundary range is adjusted and an adjustment of the boundary range, the second position range of the boundary range adjusted target content block in the target document is obtained. For example, when the reference range of the target content block is increased, the horizontal coordinate range or the vertical coordinate range of the target content block in the target document may be increased.
Step S104: Display, in the target document, the boundary range adjusted target content block based on the second position range.

After determining the second position range of the boundary range adjusted target content block in the target document, data in the reference range where the target content block is located may be rendered, so as to display the boundary range adjusted target content block on the target document.

In the document processing method according to the embodiments of the present disclosure, when a boundary range of a target content block is adjusted, a second position range of the boundary range adjusted target content block in a target document is determined based on a first position range of the target content block in the target document and a method for adjusting the boundary range, and then the target content block is displayed in the target document based on the second position range, to implement adjustment and display of the boundary range of the target content block, thereby improving flexibility and scalability in document referencing.

In some embodiments, the target document further includes a reference identification corresponding to the target content block. The method further includes: in response to receiving a trigger operation for the reference identification, displaying a first window in the target document, the first window including user reference information referencing the target content block.

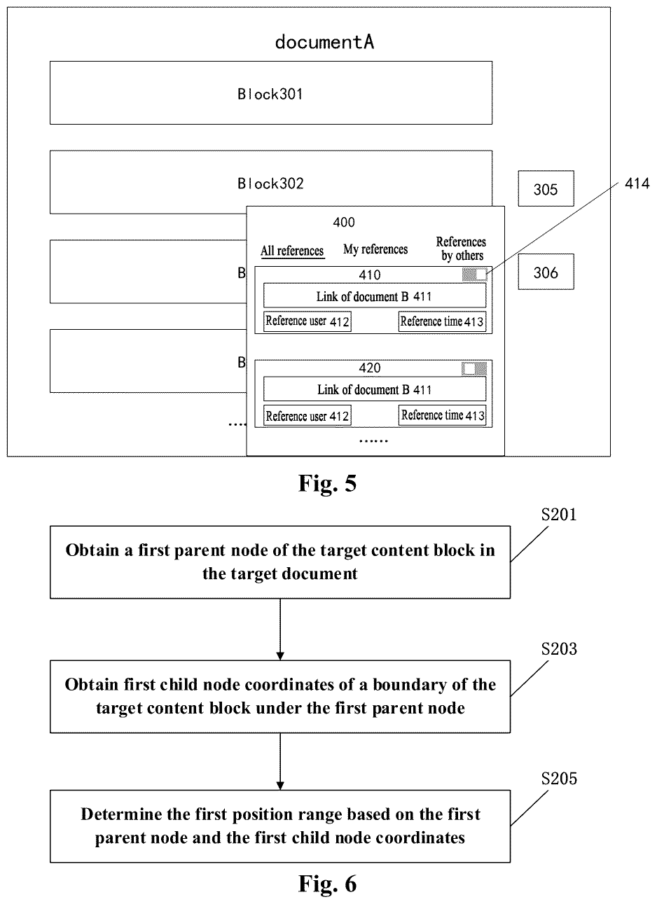

As shown in FIG. 5, a target document documentA includes content blocks Block301, Block302, Block303, Block304, . . . , where the target content blocks Block302 and Block303 are referenced by other documents. In some embodiments, a first reference identification 305 is displayed in an associated region of the target content block Block302, and a second reference identification 306 is displayed in an associated region of the target content block Block303. The first reference identification 305 or the second reference identification 306 may indicate that the corresponding target content block Block302 or Block303 is referenced. In some embodiments, the user performs a trigger operation (for example, mouse hovering, clicking, and the like) on the target content block Block302, and in response to the trigger operation, a first window 400 may be displayed in the target document documentA, where the first window 400 includes user reference information 410 and 420 referencing the target content block Block302.

In some embodiments, as shown in FIG. 5, the user reference information 410 includes a reference user name 412, a reference time 413, and link information 411 of a linked document. Through the user reference information, the name of a reference user who references the target content block, the reference time of the target content block, and the link information of the linked document that references the target content block can be learned. Optionally, the link information of the linked document includes title information of the linked document.

In some embodiments, the first window 400 includes at least one category label. After the displaying the first window in the target document, the method further includes: in response to receiving a trigger operation for a target category label in the at least one category label, displaying, in the first window, a sub-window page corresponding to the target category label, the sub-window page including user reference information corresponding to the target category label.

In these embodiments, the category label includes at least one of all user reference information, current user reference information, and other user reference information. As shown in FIG. 5, the all user reference information may be displayed as “All references” in the first window 400, and when the category label “All references” is triggered, all the user reference information is displayed in the first window 400. The current user reference information may be displayed as “My references” in the first window 400, and when the category label “My references” is triggered, the user reference information of the current user is displayed in the first window 400, where the current user reference information is reference information of an owner user of the target document. The other user reference information may be displayed as “References of others” in the first window 400, and when the category label “References of others” is triggered, the user reference information of the other user is displayed in the first window 400.

In some embodiments, the method further includes: determining whether a current user is an owner user of the target content block, the owner user being a user who has management permission or edit permission for the target content block. In response to the current user being the owner user of the target content block, adjust a boundary range of the target content block based on the boundary range adjustment operation for the target content block; and in response to the current user not being the owner user of the target content block, reject to adjust the boundary range of the target content block.

In these embodiments, before the boundary range of the target content block is adjusted, it is necessary to determine whether the current user has management permission or edit permission for the target content block. Only the owner user of the target content block can manage or edit the target content block. If the current user is the owner user of the target content block, the boundary range of the target content block may be adjusted based on the boundary range adjustment operation for the target content block. If the current user is not the owner user of the target content block, the boundary range of the target content block cannot be adjusted.

In some embodiments, the first window 400 further includes a first control 414. When the boundary range of the target content block is adjusted, if the first control 414 is in a triggered state, a corresponding boundary range adjustment is performed on the linked content block in the linked document.

In these embodiments, a first control 414 may be set in the first window 400, and the first control 414 is configured to control whether the adjustment of the boundary range of the target content block is synchronized to the linked content block in the linked document. When the first control 414 is in a triggered state, the adjustment of the boundary range of the target content block is also synchronized to the linked content block in the linked document, that is, the linked content block in the linked document is also adjusted with the adjustment of the boundary range of the target content block. When the first control 414 is not in the triggered state, the adjustment of the boundary range of the target content block is not synchronized to the linked content block in the linked document, that is, the linked content block in the linked document is not adjusted with the adjustment of the boundary range of the target content block.

Optionally, it may also be set that when the boundary range of the target content block is adjusted, even if the first control 414 is not in the triggered state, when the first control 414 is in the triggered state later, the adjustment of the boundary range of the target content block before the first control 414 is not triggered may also be synchronized to the linked content block in the linked document. Alternatively, it may also be set that when the boundary range of the target content block is adjusted, even if the first control 414 is not in the triggered state, when the first control 414 is in the triggered state later, the adjustment of the boundary range of the target content block before the first control 414 is not triggered is not synchronized to the linked content block in the linked document. This is not limited in these embodiments.

In some embodiments, as shown in FIG. 5, the first control 414 is in a one-to-one correspondence with the user reference information, that is, one first control 414 is set for each piece of user reference information, so that the user can separately control whether the adjustment of the boundary range of the target content block is synchronized to each different piece of user reference information, increasing flexibility of setting by the user. Alternatively, only one first control 414 may be set in the first window 400, and all the user reference information in the first window 400 is controlled by the first control 414. This is not limited in these embodiments.

In some embodiments, when a trigger operation for the first control 414 is received, the reference identification is continuously in a highlighted state. That is, in these embodiments, if the first control 414 is triggered, it indicates that the boundary range of the target content block where the first control 414 is located is to be adjusted. In this case, the reference identification is continuously set to the highlighted state, so that the user can know that the adjustment of the boundary range of the target content block will be synchronized to the linked document linked thereto.

In some embodiments, the target content block includes at least one child block, each child block includes one row or one column in the target content block, child blocks of the target content block include an upper boundary child block and a lower boundary child block, and the adjusting the boundary range of the target content block includes: inserting or deleting a child block in the target content block.

In these embodiments, the child blocks of the target content block include one upper boundary child block and one lower boundary child block, and the upper boundary child block is used as an upper boundary (start) of the target content block, and the lower boundary child block is used as a lower boundary (end) of the target content block. The child blocks of the target content block may further include zero (that is, the upper boundary child block and the lower boundary child block are adjacent to each other) or several (one or more) internal child blocks arranged between the upper boundary child block and the lower boundary child block, or an intermediate child block and/or a blank row is further arranged between the upper boundary child block and the lower boundary child block, or the upper boundary child block and the lower boundary child block are the same child block. This is not limited in these embodiments.

In some embodiments, the inserting a child block in the target content block includes: inserting a non-adjacent child block before the upper boundary child block or after the lower boundary child block; and the obtaining a second position range of the boundary range adjusted target content block in the target document includes: using the first position range of the target content block in the target document as the second position range of the boundary range adjusted target content block in the target document.

In these embodiments, the non-adjacent child block is inserted before the upper boundary child block or after the lower boundary child block, that is, the child block is inserted at a position spaced by at least one row before the upper boundary child block or after the lower boundary child block. This manner of inserting the child block does not affect a first parent node of the target content block and the boundary ranges of the upper boundary child block and the lower boundary child block, so that the boundary range of the target content block remains unchanged. The first position range of the target content block in the target document may be used as the second position range of the boundary range adjusted target content block in the target document.

In some embodiments, the inserting a child block in the target content block includes: inserting a child block between the upper boundary child block and the lower boundary child block; and the obtaining a second position range of the boundary range adjusted target content block in the target document includes: determining the second position range based on a boundary position of the upper boundary child block and a boundary position of the lower boundary child block after the child block is added.

In these embodiments, when the child block is inserted between the upper boundary child block and the lower boundary child block, the boundary range of the upper boundary child block remains unchanged, and the boundary range of the upper boundary child block may be directly used as the boundary range of the upper boundary child block of the boundary range adjusted target content block. In addition, since the child block is inserted (one child block is taken as an example), the lower boundary child block is adjusted downward by one row after the boundary range is adjusted. Therefore, the second position range may be determined based on the boundary position of the lower boundary child block after the child block is added.

In some embodiments, the inserting a child block in the target content block includes: inserting an adjacent child block before the upper boundary child block and declaring the adjacent child block as a non-changeable boundary; and the obtaining a second position range of the boundary range adjusted target content block in the target document includes: determining the second position range based on a boundary position of the upper boundary child block after the child block is added and a boundary position of the lower boundary child block.

In these embodiments, the adjacent child block is inserted before the upper boundary child block, that is, the child block is directly inserted at a position not spaced by rows before the upper boundary child block. When the non-changeable boundary is declared, that is, adding the child block does not affect the boundary of the target content block, the content of the upper boundary child block and the lower boundary child block remains unchanged. However, since the inserted child block and the upper boundary child block are the adjacent child blocks, the boundary positions of the upper boundary child block and the lower boundary child block may be adjusted based on a quantity of inserted child blocks, so that the second position range may be determined based on the boundary position of the upper boundary child block after the child block is added and the boundary position of the lower boundary child block.

In some embodiments, the inserting a child block in the target content block includes: inserting an adjacent child block before the upper boundary child block and declaring the adjacent child block as a changeable boundary; and the obtaining a second position range of the boundary range adjusted target content block in the target document includes: determining the second position range based on a boundary position of the inserted child block and a boundary position of the lower boundary child block after the child block is inserted.

In these embodiments, the adjacent child block is inserted before the upper boundary child block, that is, the child block is directly inserted at a position not spaced by rows before the upper boundary child block. When the changeable boundary is declared, that is, adding the child block affects the boundary of the target content block, the inserted child block becomes a new upper boundary child block of the target content block, and the second position range may be determined based on the boundary position of the inserted child block. In addition, the content of the lower boundary child block remains unchanged. However, since the inserted child block and the upper boundary child block are the adjacent child blocks, the second position range may be determined based on the boundary position of the lower boundary child block after the child block is inserted.

In some embodiments, the inserting a child block in the target content block includes: inserting an adjacent child block after the lower boundary child block and declaring the adjacent child block as a non-changeable boundary; and the obtaining a second position range of the boundary range adjusted target content block in the target document includes: determining the second position range based on a boundary position of the upper boundary child block and a boundary position of the lower boundary child block.

In these embodiments, the adjacent child block is inserted after the lower boundary child block, that is, the child block is directly inserted at a position not spaced by rows after the lower boundary child block. When the non-changeable boundary is declared, that is, adding the child block does not affect the boundary of the target content block, the content of the upper boundary child block and the lower boundary child block remains unchanged.

In some embodiments, the inserting a child block in the target content block includes: inserting an adjacent child block after the lower boundary child block and declaring the adjacent child block as a changeable boundary; and the obtaining a second position range of the boundary range adjusted target content block in the target document includes: determining the second position range based on a boundary position of the upper boundary child block and a boundary position of the lower boundary child block after the child block is inserted.

In these embodiments, the adjacent child block is inserted after the lower boundary child block, that is, the child block is directly inserted at a position not spaced by rows after the lower boundary child block. When the changeable boundary is declared, that is, adding the child block affects the boundary of the target content block, the upper boundary child block remains unchanged, and the inserted child block is used as a new lower boundary child block. The second position range may be determined based on the boundary position of the upper boundary child block and the boundary position of the lower boundary child block after the child block is inserted.

In some embodiments, the deleting a child block in the target content block includes: deleting the child block before the upper boundary child block or after the lower boundary child block; and the obtaining a second position range of the boundary range adjusted target content block in the target document includes: using the first position range of the target content block in the target document as the second position range of the boundary range adjusted target content block in the target document.

In these embodiments, the child block is deleted before the upper boundary child block or after the lower boundary child block. This manner of deleting the child block does not affect the upper boundary child block and the lower boundary child block of the target content block, so that the upper boundary child block and the lower boundary child block of the target content block remain unchanged.

In some embodiments, the deleting a child block in the target content block includes: deleting a child block between the upper boundary child block and the lower boundary child block; and the obtaining a second position range of the boundary range adjusted target content block in the target document includes: determining the second position range based on a boundary position of the upper boundary child block and a boundary position of the lower boundary child block after the child block is deleted.

In these embodiments, the child block is deleted between the upper boundary child block and the lower boundary child block. This manner of deleting the child block does not affect the upper boundary child block and the lower boundary child block of the target content block. Since the deleted child block is after the upper boundary, the boundary position of the upper boundary child block remains unchanged. In addition, since the child block before the lower boundary child block is deleted, the boundary position of the lower boundary child block changes. Therefore, the second position range may be determined based on the boundary position of the upper boundary child block and the boundary position of the lower boundary child block after the child block is deleted.

In some embodiments, the deleting a child block in the target content block includes: deleting the upper boundary child block; and the obtaining a second position range of the boundary range adjusted target content block in the target document includes: determining the second position range based on a boundary position of an internal child block adjacent to the upper boundary child block and a boundary position of the lower boundary child block; or determining the second position range based on the boundary position of the lower boundary child block; or the target content block being empty.

In these embodiments, when the target content block includes the upper boundary child block, the lower boundary child block, and at least one internal child block located between the upper boundary child block and the lower boundary child block, after the upper boundary child block is deleted, the internal child block adjacent to the upper boundary child block may be confirmed as a new upper boundary child block. In this case, the boundary range of the close internal child block is the boundary range of the new upper boundary child block. When the target content block includes only the upper boundary child block and the lower boundary child block, after the upper boundary child block is deleted, the lower boundary child block may be confirmed as the new upper boundary child block, that is, the boundary range of the lower boundary child block is also the boundary range of the new upper boundary child block. When the upper boundary child block and the lower boundary child block of the target content block are the same child block, after the upper boundary child block is deleted, the target content block is empty, that is, the target content block is deleted.

In some embodiments, the deleting a child block in the target content block includes: deleting the lower boundary child block; and the obtaining a second position range of the boundary range adjusted target content block in the target document includes: determining the second position range based on a boundary position of the upper boundary child block and a boundary position of an internal child block adjacent to the lower boundary child block; or determining the second position range based on the boundary position of the upper boundary child block; or the target content block being empty.

In these embodiments, when the target content block includes the upper boundary child block, the lower boundary child block, and at least one internal child block located between the upper boundary child block and the lower boundary child block, after the lower boundary child block is deleted, the internal child block adjacent to the lower boundary child block may be confirmed as a new lower boundary child block. In this case, the boundary range of the close internal child block is the boundary range of the new lower boundary child block. When the target content block includes only the upper boundary child block and the lower boundary child block, after the lower boundary child block is deleted, the upper boundary child block may be confirmed as the new upper boundary child block, that is, the boundary range of the upper boundary child block is also the boundary range of the new lower boundary child block after the boundary range is adjusted. When the upper boundary child block and the lower boundary child block of the target content block are the same child block, after the lower boundary child block is deleted, the target content block is empty, that is, the target content block is deleted.

In some embodiments, as shown in FIG. 6, the obtaining a first position range of the target content block in the target document in step S103 includes:
Step S201: Obtain a first parent node of the target content block in the target document.

In these embodiments, content in the target document may be stored in a format of a document tree, and each content block is used as a node of the document tree. For example, a plurality of content blocks arranged in parallel may be edited as sibling nodes into the document tree. If a certain content block includes a child content block, the child content block is used as a child node of the content block. A front-back relationship of each content block may be set to a sequence in which the document tree of the target document is traversed. A node that is traversed earlier is before a node that is traversed later, and the node that is traversed later is after the node that is traversed earlier.

In this way, the first parent node parent_id of the target content block in the target document may be obtained according to a structure of the document tree of the target document.
Step S203: Obtain first child node coordinates of a boundary of the target content block under the first parent node.

In these embodiments, a position of the boundary of the target content block may be marked by using coordinates, for example, first child node coordinates (start, end). The first child node coordinates are coordinates under the first parent node.
Step S205: Determine the first position range based on the first parent node and the first child node coordinates.

In these embodiments, the first position range of the target content block in the target document may be determined based on the first parent node parent_id and the first child node coordinates (start, end).

In some embodiments, the target content block includes at least one child block. When words, pictures, and the like in the target document are stored and displayed horizontally, each child block includes one row in the target content block; and when words, pictures, and the like in the target document are stored and displayed vertically, each child block includes one column in the target content block. In these embodiments, one row in the target content block is used as one child block as an example to describe the technical solution according to the embodiments of the present disclosure.

The boundary of the target content block is a child block located at an edge in the target content block.

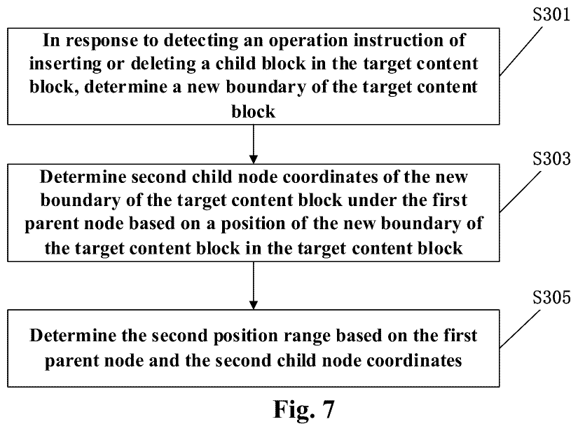

In some embodiments, the adjusting the boundary range of the target content block includes inserting or deleting a child block in the target content block. As shown in FIG. 7, in step S105, the obtaining a second position range of the boundary range adjusted target content block in the target document includes:
Step S301: In response to detecting an operation instruction for inserting or deleting a child block in the target content block, determine a new boundary of the target content block.

In these embodiments, the target document needs to be listened to. During listening, when a change in the target document is detected, that is, when an operation such as inserting or deleting a child block in the target content block in the target document is performed, the operation instruction for inserting or deleting the child block in the target content block may be detected. In this case, a change process of the target content block is listened to, and the local target document is directly adjusted based on the change process of the target content block. Specifically, a boundary of the target content block after a child block is inserted or deleted may be used as the new boundary. It should be noted that in these embodiments, the new boundary may be the same as or different from the boundary of the target content block before the child block is inserted or deleted. This is not limited in these embodiments.

After the operation of inserting or deleting the child block is performed on the target content block, the boundary of the target content block may also change, and then the new boundary is generated. For example, inserting a child block outside a boundary, deleting a child block belonging to a certain boundary, and the like may all cause the boundary of the target content block to change, and then the new boundary is generated. Alternatively, even if the content of the boundary does not change, the first child node coordinates of the boundary may also change.
Step S303: Determine second child node coordinates of the new boundary of the target content block under the first parent node based on a position of the new boundary of the target content block in the target content block.
Step S305: Determine the second position range based on the first parent node and the second child node coordinates.

In these embodiments, after the operation of inserting or deleting the child block is performed on the target content block, the second child node coordinates of the new boundary of the target content block under the first parent node are determined based on a position of the new boundary of the target content block in the target content block. Finally, the second position range may be determined based on the first parent node and the second child node coordinates.

In some embodiments, the child blocks of the target content block include one upper boundary child block and one lower boundary child block, and the upper boundary child block is used as an upper boundary (start) of the target content block, and the lower boundary child block is used as a lower boundary (end) of the target content block. The child blocks of the target content block may further include zero (that is, the upper boundary child block and the lower boundary child block are adjacent to each other) or several (one or more) internal child blocks arranged between the upper boundary child block and the lower boundary child block, or an intermediate child block and/or a blank row is further arranged between the upper boundary child block and the lower boundary child block, or the upper boundary child block and the lower boundary child block are the same child block. This is not limited in these embodiments.

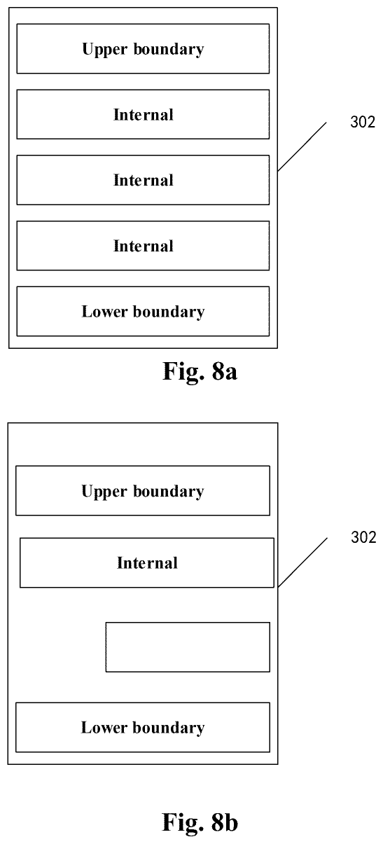

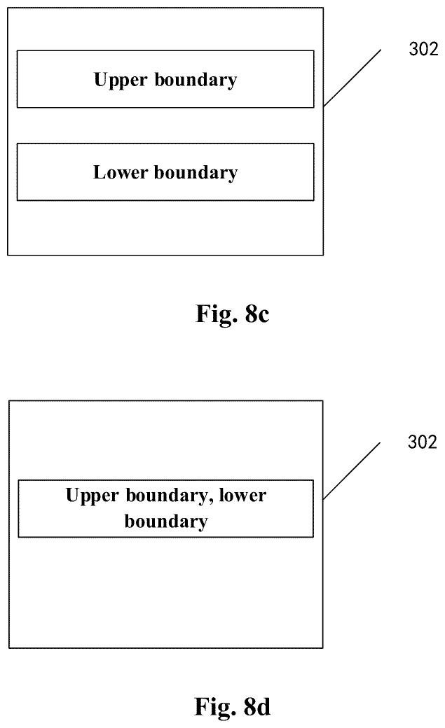

As shown in FIG. 8a, the target content block may include the upper boundary child block, the lower boundary child block, and one or more internal child blocks arranged between the upper boundary child block and the lower boundary child block. As shown in FIG. 8b, the target content block may include the upper boundary child block, the lower boundary child block, and the internal child block arranged between the upper boundary child block and the lower boundary child block. In addition, elements such as a blank space may be further included. As shown in FIG. 8c, the target content block may include only the upper boundary child block and the lower boundary child block, and no internal child block is arranged. As shown in FIG. 8d, the target content block may include only one child block, and the child block is both the upper boundary child block and the lower boundary child block. In addition, the target content block may have another structure. This is not limited in these embodiments.

In some embodiments, the inserting a child block in the target content block includes: inserting a non-adjacent child block before the upper boundary child block or after the lower boundary child block; and the determining a new boundary of the target content block after the operation of inserting the child block in the target content block is performed, and determining second child node coordinates of the new boundary of the target content block under the first parent node based on a position of the new boundary of the target content block in the target content block includes: keeping the upper boundary child block and the lower boundary child block unchanged, and using the first child node coordinates of the upper boundary child block and the lower boundary child block as the boundary range adjusted second child node coordinates of the upper boundary child block and the lower boundary child block, respectively.

In these embodiments, the non-adjacent child block is inserted before the upper boundary child block or after the lower boundary child block, that is, the child block is inserted at a position spaced by at least one row before the upper boundary child block or after the lower boundary child block. This manner of inserting the child block does not affect the first parent node of the target content block and the first child node coordinates of the upper boundary child block and the lower boundary child block, so that the first parent node of the target content block remains unchanged, and the first child node coordinates of the upper boundary child block and the lower boundary child block remain unchanged. The first child node coordinates of the upper boundary child block and the lower boundary child block may be directly used as the boundary range adjusted second child node coordinates of the upper boundary child block and the lower boundary child block, respectively.

In some embodiments, the inserting a child block in the target content block includes: inserting a child block between the upper boundary child block and the lower boundary child block; and the determining a new boundary of the target content block after the operation of inserting the child block in the target content block is performed, and determining second child node coordinates of the new boundary of the target content block under the first parent node based on a position of the new boundary of the target content block in the target content block includes: keeping the upper boundary child block and the lower boundary child block unchanged, using the first child node coordinates of the upper boundary child block as the boundary range adjusted second child node coordinates of the upper boundary child block, and increasing the first child node coordinates of the lower boundary child block based on the inserted child block to generate the boundary range adjusted second child node coordinates of the lower boundary child block.

In these embodiments, when the child block is inserted between the upper boundary child block and the lower boundary child block, a parent node of the child block is the same as the upper boundary child block and the lower boundary child block. The content and the coordinates of the upper boundary child block remain unchanged, and the first child node coordinates of the upper boundary child block may be directly used as the second child node coordinates of the upper boundary child block of the boundary range adjusted target content block. In addition, since the child block is inserted (one child block is taken as an example), the lower boundary child block is adjusted downward by one row after the boundary range is adjusted. Therefore, the coordinates of the lower boundary child block are increased (that is, end+1), to determine the second child node coordinates of the lower boundary child block.

In some embodiments, the inserting a child block in the target content block includes: inserting an adjacent child block before the upper boundary child block and declaring the adjacent child block as a non-changeable boundary; and the determining a new boundary of the target content block after the operation of inserting the child block in the target content block is performed, and determining second child node coordinates of the new boundary of the target content block under the first parent node based on a position of the new boundary of the target content block in the target content block includes: keeping the upper boundary child block unchanged, and increasing the first child node coordinates of the upper boundary child block and the lower boundary child block based on the inserted child block to generate the boundary range adjusted second child node coordinates of the upper boundary child block and the lower boundary child block.

In these embodiments, the adjacent child block is inserted before the upper boundary child block, that is, the child block is directly inserted at a position not spaced by rows before the upper boundary child block. When the non-changeable boundary is declared, that is, adding the child block does not affect the boundary of the target content block, the content of the upper boundary child block and the lower boundary child block remains unchanged. However, since the inserted child block and the upper boundary child block are the adjacent child blocks, that is, a close node of a node where the upper boundary child block is located is inserted in the document tree (one inserted node is taken as an example), positions of the upper boundary child block and the lower boundary child block under the parent node are changed. For example, the upper boundary child block is originally a first child node under the parent node, and another child node is inserted before the child node, so that the child node to which the upper boundary child block belongs becomes a second child node under the parent node. Therefore, the first child node coordinates of the upper boundary child block and the lower boundary child block may be increased by a quantity of the inserted child blocks (start+1, end+1), and the increased first child node coordinates are used as the second child node coordinates of the upper boundary child block and the lower boundary child block.

In some embodiments, the inserting a child block in the target content block includes: in response to inserting an adjacent child block before the upper boundary child block and declaring the adjacent child block as a changeable boundary; and the determining a new boundary of the target content block after the operation of inserting the child block in the target content block is performed, and determining second child node coordinates of the new boundary of the target content block under the first parent node based on a position of the new boundary of the target content block in the target content block includes: using the inserted child block as a new upper boundary child block of the target content block, determining the second child node coordinates of the new upper boundary child block based on a position of the inserted child block in the target content block, and increasing the first child node coordinates of the lower boundary child block based on the inserted child block to generate the boundary range adjusted second child node coordinates of the lower boundary child block.

In these embodiments, the adjacent child block is inserted before the upper boundary child block, that is, the child block is directly inserted at a position not spaced by rows before the upper boundary child block. When the changeable boundary is declared, that is, adding the child block affects the boundary of the target content block, the inserted child block becomes the new upper boundary child block of the target content block, and the first child node coordinates of the original upper boundary child block are the second child node coordinates of the new upper boundary child block. In addition, the content of the lower boundary child block remains unchanged. However, since the inserted child block and the upper boundary child block are the adjacent child blocks, that is, a close node of a node where the upper boundary child block is located is inserted in the document tree (one inserted node is taken as an example), a position of the lower boundary child block under the parent node is changed. For example, the lower boundary child block is originally a third child node under the parent node, and another child node is inserted before the child node, so that the child node to which the lower boundary child block belongs becomes a fourth child node under the parent node. Therefore, the first child node coordinates of the lower boundary child block may be increased by a quantity of the inserted child blocks (end+1), and the increased first child node coordinates are used as the second child node coordinates of the lower boundary child block.

In some embodiments, the inserting a child block in the target content block includes: in response to inserting an adjacent child block after the lower boundary child block and declaring the adjacent child block as a non-changeable boundary; and the determining a new boundary of the target content block after the operation of inserting the child block in the target content block is performed, and determining second child node coordinates of the new boundary of the target content block under the first parent node based on a position of the new boundary of the target content block in the target content block includes: using the first child node coordinates of the upper boundary child block and the lower boundary child block as the boundary range adjusted second child node coordinates of the upper boundary child block and the lower boundary child block, respectively.

In these embodiments, the adjacent child block is inserted after the lower boundary child block, that is, the child block is directly inserted at a position not spaced by rows after the lower boundary child block. When the non-changeable boundary is declared, that is, adding the child block does not affect the boundary of the target content block, the content of the upper boundary child block and the lower boundary child block remains unchanged, and the coordinates of the upper boundary child block and the lower boundary child block remain unchanged. Therefore, the first child node coordinates of the upper boundary child block and the lower boundary child block may be directly used as the boundary range adjusted second child node coordinates of the upper boundary child block and the lower boundary child block, respectively.

In some embodiments, the inserting a child block in the target content block includes: in response to inserting an adjacent child block after the lower boundary child block and declaring the adjacent child block as a changeable boundary; and the determining a new boundary of the target content block after the operation of inserting the child block in the target content block is performed, and determining second child node coordinates of the new boundary of the target content block under the first parent node based on a position of the new boundary of the target content block in the target content block includes: using the first child node coordinates of the upper boundary child block as the boundary range adjusted second child node coordinates of the upper boundary child block, using the inserted child block as a new lower boundary child block of the target content block, and determining the second child node coordinates of the new lower boundary child block based on a position of the inserted child block in the target content block.

In these embodiments, the adjacent child block is inserted after the lower boundary child block, that is, the child block is directly inserted at a position not spaced by rows after the lower boundary child block. When the changeable boundary is declared, that is, adding the child block affects the boundary of the target content block, the upper boundary child block remains unchanged, and the inserted child block is used as the new lower boundary child block. For example, when one child block is inserted, the coordinates of the new lower boundary child block are the coordinates of the original lower boundary child block+1 (end+1), to determine the boundary range adjusted second child node coordinates of the lower boundary child block.

In some embodiments, the deleting a child block in the target content block includes: deleting the child block before the upper boundary child block or after the lower boundary child block; and the determining a new boundary of the target content block after the operation of inserting the child block in the target content block is performed, and determining second child node coordinates of the new boundary of the target content block under the first parent node based on a position of the new boundary of the target content block in the target content block includes: keeping the upper boundary child block and the lower boundary child block unchanged, and calculating the boundary range adjusted second child node coordinates of the upper boundary child block and the lower boundary child block based on the deleted child block and the first child node coordinates of the upper boundary child block and the lower boundary child block, respectively.

In these embodiments, the child block is deleted before the upper boundary child block or after the lower boundary child block. This manner of deleting the child block does not affect the upper boundary child block and the lower boundary child block of the target content block, so that the upper boundary child block and the lower boundary child block of the target content block remain unchanged. When the child block is deleted after the lower boundary child block, the first child node coordinates of the upper boundary child block and the lower boundary child block remain unchanged. The first child node coordinates of the upper boundary child block and the lower boundary child block may be directly used as the boundary range adjusted second child node coordinates of the upper boundary child block and the lower boundary child block, respectively. When the child block is deleted before the upper boundary child block, if a child block under the first parent node is not deleted, the first child node coordinates of the upper boundary child block and the lower boundary child block remain unchanged. The first child node coordinates of the upper boundary child block and the lower boundary child block may be directly used as the boundary range adjusted second child node coordinates of the upper boundary child block and the lower boundary child block, respectively. If the child block under the first parent node is deleted (one deleted child block is taken as an example), the first child node coordinates of the upper boundary child block and the lower boundary child block are reduced (start−1, end−1) and used as the second child node coordinates of the upper boundary child block and the lower boundary child block.

In some embodiments, the deleting a child block in the target content block includes: deleting a child block between the upper boundary child block and the lower boundary child block; and the determining a new boundary of the target content block after the operation of inserting the child block in the target content block is performed, and determining second child node coordinates of the new boundary of the target content block under the first parent node based on a position of the new boundary of the target content block in the target content block includes: keeping the upper boundary child block and the lower boundary child block unchanged, using the first child node coordinates of the upper boundary child block as the boundary range adjusted second child node coordinates of the upper boundary child block, and reducing the first child node coordinates of the lower boundary child block based on the deleted child block to generate the boundary range adjusted second child node coordinates of the lower boundary child block.

In these embodiments, the child block is deleted between the upper boundary child block and the lower boundary child block. This manner of deleting the child block does not affect the upper boundary child block and the lower boundary child block of the target content block. Since the deleted child block is after the upper boundary, the first child node coordinates of the upper boundary child block remain unchanged. The first child node coordinates of the upper boundary child block may be used as the boundary range adjusted second child node coordinates of the upper boundary child block. In addition, since the child block before the lower boundary child block is deleted (one deleted child block is taken as an example), the first child node coordinates of the lower boundary child block are reduced (end−1), to obtain the boundary range adjusted second child node coordinates of the lower boundary child block.

In some embodiments, the deleting a child block in the target content block includes: deleting the upper boundary child block; and the determining a new boundary of the target content block after the operation of inserting the child block in the target content block is performed, and determining second child node coordinates of the new boundary of the target content block under the first parent node based on a position of the new boundary of the target content block in the target content block includes: determining an internal child block adjacent to the upper boundary child block or the lower boundary child block as a new upper boundary child block, and using the first child node coordinates of the internal child block adjacent to the upper boundary child block or the lower boundary child block as the boundary range adjusted second child node coordinates of the new upper boundary child block; or the target content block being empty.

In these embodiments, when the target content block includes the upper boundary child block, the lower boundary child block, and at least one internal child block located between the upper boundary child block and the lower boundary child block, after the upper boundary child block is deleted, the internal child block adjacent to the upper boundary child block may be confirmed as the new upper boundary child block. In this case, the second child node coordinates of the new upper boundary child block are the first child node coordinates of the original upper boundary child block. When the target content block includes only the upper boundary child block and the lower boundary child block, after the upper boundary child block is deleted, the lower boundary child block may be confirmed as the new upper boundary child block. In this case, the second child node coordinates of the new upper boundary child block and the lower boundary child block are the first child node coordinates of the original upper boundary child block. When the upper boundary child block and the lower boundary child block of the target content block are the same child block, after the upper boundary child block is deleted, the target content block is empty, that is, the target content block is deleted.

In some embodiments, the deleting a child block in the target content block includes: deleting the lower boundary child block; and the determining a new boundary of the target content block after the operation of inserting the child block in the target content block is performed, and determining second child node coordinates of the new boundary of the target content block under the first parent node based on a position of the new boundary of the target content block in the target content block includes: determining an internal child block adjacent to the lower boundary child block or the upper boundary child block as a new lower boundary child block, and using the first child node coordinates of the internal child block adjacent to the lower boundary child block or the upper boundary child block as the boundary range adjusted second child node coordinates of the new lower boundary child block; or the target content block being empty.

In these embodiments, when the target content block includes the upper boundary child block, the lower boundary child block, and at least one internal child block located between the upper boundary child block and the lower boundary child block, after the lower boundary child block is deleted, the internal child block adjacent to the lower boundary child block may be confirmed as the new lower boundary child block. In this case, the second child node coordinates of the new lower boundary child block are the first child node coordinates of the close internal child block. When the target content block includes only the upper boundary child block and the lower boundary child block, after the lower boundary child block is deleted, the upper boundary child block may be confirmed as the new upper boundary child block. In this case, the target content block includes only one child block, and the first child node coordinates of the upper boundary child block are the boundary range adjusted second child node coordinates of the upper boundary child block and the new lower boundary child block. When the upper boundary child block and the lower boundary child block of the target content block are the same child block, after the lower boundary child block is deleted, the target content block is empty, that is, the target content block is deleted.

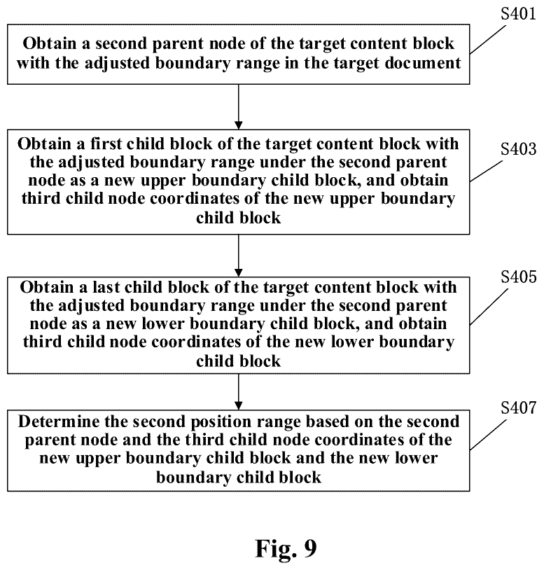

In some other embodiments, as shown in FIG. 9, the obtaining a second position range of the boundary range adjusted target content block in the target document in step S105 further includes:
Step S401: Obtain a second parent node of the boundary range adjusted target content block in the target document.
Step S403: Obtain a first child block of the boundary range adjusted target content block under the second parent node as a new upper boundary child block, and obtain third child node coordinates of the new upper boundary child block.
Step S405: Obtain a last child block of the boundary range adjusted target content block under the second parent node as a new lower boundary child block, and obtain third child node coordinates of the new lower boundary child block.
Step S407: Determine the second position range based on the second parent node and the third child node coordinates of the new upper boundary child block and the new lower boundary child block.

In these embodiments, when the change in the target document cannot be listened to in real time or the boundary range adjusted target content block is empty when the target document is listened to in real time, the target document displayed on the front-end page cannot be adjusted according to the change in the target document listened to in real time. In this case, the reference range of the boundary range adjusted target content block is stored in a back-end database, and the latest reference range is pushed to the target document on the front-end page through a mailbox of the target content block, so that the boundary range adjusted target content block is displayed in the target document.

In some embodiments, after the obtaining a second position range of the boundary range adjusted target content block in the target document in step S105, the method further includes: sending the second position range to the associated document, so that the associated document redisplays the associated content block in the associated document based on the second position range.

In these embodiments, after the boundary range of the target content block in the target document is adjusted, the second position range is sent to the associated document, to render display content of the associated document, so that a corresponding document block in the associated document is the same as the boundary range adjusted target content block in the target document.

Optionally, in these embodiments, an update permission may be set for the associated document to limit whether to update updated content in the target content block in the target document to the associated document. When the update is allowed, the display content of the associated document is rendered based on the second position range; otherwise, the display content of the associated document is not changed.

It should be noted that the method according to the embodiments of the present disclosure may be performed by a single device, for example, one computer or server. The method according to these embodiments may also be applied to a distributed scenario, and completed by a plurality of devices cooperating with each other. In this distributed scenario, one of the plurality of devices may only perform one or more steps of the method according to the embodiments of the present disclosure, and the plurality of devices exchange information with each other to complete the method.

It should be noted that some embodiments of the present disclosure are described above. Other embodiments are within the scope of the appended claims. In some cases, the actions or steps recited in the claims may be performed in a different order than in the embodiments described above and still achieve the desired results. In addition, the processes depicted in the accompanying drawings do not necessarily require the specific order or sequential order shown to achieve the desired results. In some implementations, multitasking and parallel processing may also be possible or advantageous.

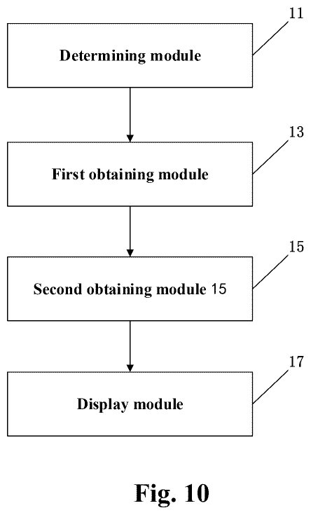

Based on the same inventive concept, corresponding to the method in any of the foregoing embodiments, the present disclosure further provides a document processing apparatus. As shown in FIG. 10, the apparatus includes:
a determining module 11, configured to determine a target content block in a target document, wherein the target content block has a reference relationship with an associated content block in an associated document;
a first obtaining module 13, configured to obtain a first position range of the target content block in the target document;
a second obtaining module 15, configured to: in response to receiving an operation of adjusting a boundary range of the target content block, obtain a second position range of the boundary range adjusted target content block in the target document; and
a display module 17, configured to display, in the target document, the boundary range adjusted target content block based on the second position range.

In some embodiments, the target document further includes a reference identification corresponding to the target content block; and the apparatus is further configured to: in response to receiving a trigger operation for the reference identification, display a first window in the target document, wherein the first window comprises user reference information that references the target content block.

In some embodiments, the user reference information comprises a reference user name, a reference time, and link information of an associated document.

In some embodiments, the first window includes at least one category label; and after the first window is displayed in the target document, the apparatus is further configured to: in response to receiving a trigger operation for a target category label in the at least one category label, display, in the first window, a sub-window page corresponding to the target category label, wherein the sub-window page displays user reference information corresponding to the target category label, wherein the category label comprises at least one of all user reference information, current user reference information, and other user reference information, and the current user reference information is reference information of an owner user of the target document.

In some embodiments, the apparatus is further configured to: determine whether a current user is a user to whom the target content block belongs, wherein the owner user of the target document is a user having management permission or edit permission for the target content block; in response to the current user being the owner user of the target document, adjust the boundary range of the target content block based on an operation of adjusting the boundary range of the target content block; and in response to the current user not being the owner user of the target document, reject the adjustment of the boundary range of the target content block.

In some embodiments, the first window further includes a first control; and the apparatus is further configured to: in response to the boundary range of the target content block being adjusted, in a case that the first control is in a triggered state, adjust a boundary range of the associated content block in the associated document accordingly.

In some embodiments, the first control is in a one-to-one correspondence with the user reference information.

In some embodiments, the apparatus is further configured to: in response to receiving a trigger operation for the first control, keep the reference identification in a highlighted state.

In some embodiments, the target content block includes at least one child block, each child block includes one row or one column in the target content block, and the child blocks of the target content block include an upper boundary child block and a lower boundary child block; and the second obtaining module 15 is further configured to: insert or delete a child block in the target content block.

In some embodiments, the inserting a child block in the target content block includes: inserting a non-adjacent child block before the upper boundary child block or after the lower boundary child block; and
the second obtaining module 15 is further configured to: determine the first position range of the target content block in the target document as the second position range of the boundary range adjusted target content block in the target document.

In some embodiments, the inserting a child block in the target content block includes: inserting a child block between the upper boundary child block and the lower boundary child block; and
the second obtaining module 15 is further configured to: determine the second position range based on a boundary position of the upper boundary child block and a boundary position of the lower boundary child block after the child block is added.

In some embodiments, the inserting a child block in the target content block includes: inserting an adjacent child block before the upper boundary child block and declaring the adjacent child block as a non-changeable boundary; and
the second obtaining module 15 is further configured to: determine the second position range based on a boundary position of the upper boundary child block after the child block is added and a boundary position of the lower boundary child block.

In some embodiments, the inserting a child block in the target content block includes: inserting an adjacent child block before the upper boundary child block and declaring the adjacent child block as a changeable boundary; and
the second obtaining module 15 is further configured to: determine the second position range based on a boundary position of the inserted child block and a boundary position of the lower boundary child block after the child block is inserted.

In some embodiments, the inserting a child block in the target content block includes: in response to inserting an adjacent child block after the lower boundary child block and declaring the adjacent child block as a non-changeable boundary; and
the second obtaining module 15 is further configured to: determine the second position range based on a boundary position of the upper boundary child block and a boundary position of the lower boundary child block.

In some embodiments, the inserting a child block in the target content block includes: in response to inserting an adjacent child block after the lower boundary child block and declaring the adjacent child block as a changeable boundary; and
the second obtaining module 15 is further configured to: determine the second position range based on a boundary position of the upper boundary child block and a boundary position of the lower boundary child block after the child block is inserted.

In some embodiments, the deleting a child block in the target content block includes: deleting the child block before the upper boundary child block or after the lower boundary child block; and
the second obtaining module 15 is further configured to: determine the first position range of the target content block in the target document as the second position range of the boundary range adjusted target content block in the target document.

In some embodiments, the deleting a child block in the target content block includes: deleting a child block between the upper boundary child block and the lower boundary child block; and
the second obtaining module 15 is further configured to: determine the second position range based on a boundary position of the upper boundary child block and a boundary position of the lower boundary child block after the child block is deleted.

In some embodiments, the deleting a child block in the target content block includes: deleting the upper boundary child block;
the second obtaining module 15 is further configured to: determine the second position range based on a boundary position of an internal child block adjacent to the upper boundary child block and a boundary position of the lower boundary child block; or determine the second position range based on the boundary position of the lower boundary child block; or the target content block is empty.

In some embodiments, the deleting a child block in the target content block includes: deleting the lower boundary child block;
the second obtaining module 15 is further configured to: determine the second position range based on a boundary position of the upper boundary child block and a boundary position of an internal child block adjacent to the lower boundary child block; or determine the second position range based on the boundary position of the upper boundary child block; or the target content block is empty.

In some embodiments, the first obtaining module 13 is further configured to: obtain a first parent node of the target content block in the target document; obtain first child node coordinates of a boundary of the target content block under the first parent node; and determine the first position range based on the first parent node and the first child node coordinates.

In some embodiments, the target content block includes at least one child block, each child block includes one row or one column in the target content block, and the child blocks of the target content block include an upper boundary child block and a lower boundary child block; and
the second obtaining module 15 is further configured to: insert or delete a child block in the target content block;
the second obtaining module 15 is further configured to: after detecting an operation instruction of inserting or deleting the child block in the target content block, determine a new boundary of the target content block; determine second child node coordinates of the new boundary of the target content block under the first parent node based on a position of the new boundary of the target content block in the target content block; and determine the second position range based on the first parent node and the second child node coordinates.

In some embodiments, the inserting a child block in the target content block includes: inserting a non-adjacent child block before the upper boundary child block or after the lower boundary child block; and
the second obtaining module 15 is further configured to: keep the upper boundary child block and the lower boundary child block unchanged, and determine the first child node coordinates of the upper boundary child block and the lower boundary child block as the boundary range adjusted second child node coordinates of the upper boundary child block and the lower boundary child block, respectively.

In some embodiments, the inserting a child block in the target content block includes: inserting a child block between the upper boundary child block and the lower boundary child block; and
the second obtaining module 15 is further configured to: keep the upper boundary child block and the lower boundary child block unchanged, determine the first child node coordinates of the upper boundary child block as the boundary range adjusted second child node coordinates of the upper boundary child block, and increase the first child node coordinates of the lower boundary child block based on the inserted child block to generate the boundary range adjusted second child node coordinates of the lower boundary child block.

In some embodiments, the inserting a child block in the target content block includes: inserting an adjacent child block before the upper boundary child block and declaring the adjacent child block as a non-changeable boundary; and
the second obtaining module 15 is further configured to: keep the upper boundary child block unchanged, and increase the first child node coordinates of the upper boundary child block and the lower boundary child block based on the inserted child block to generate the boundary range adjusted second child node coordinates of the upper boundary child block and the lower boundary child block.

In some embodiments, the inserting a child block in the target content block includes: inserting an adjacent child block before the upper boundary child block and declaring the adjacent child block as a changeable boundary; and
the second obtaining module 15 is further configured to: determine the inserted child block as a new upper boundary child block of the target content block, determine the second child node coordinates of the new upper boundary child block based on a position of the inserted child block in the target content block, and increase the first child node coordinates of the lower boundary child block based on the inserted child block to generate the boundary range adjusted second child node coordinates of the lower boundary child block.

In some embodiments, the inserting a child block in the target content block includes: in response to inserting an adjacent child block after the lower boundary child block and declaring the adjacent child block as a non-changeable boundary; and
the second obtaining module 15 is further configured to: determine the first child node coordinates of the upper boundary child block and the lower boundary child block as the boundary range adjusted second child node coordinates of the upper boundary child block and the lower boundary child block, respectively.

In some embodiments, the inserting a child block in the target content block includes: in response to inserting an adjacent child block after the lower boundary child block and declaring the adjacent child block as a changeable boundary; and
the second obtaining module 15 is further configured to: determine the first child node coordinates of the upper boundary child block as the boundary range adjusted second child node coordinates of the upper boundary child block, determine the inserted child block as a new lower boundary child block of the target content block, and determine the second child node coordinates of the new lower boundary child block based on a position of the inserted child block in the target content block.

In some embodiments, the deleting a child block in the target content block includes: deleting the child block before the upper boundary child block or after the lower boundary child block; and
the second obtaining module 15 is further configured to: keep the upper boundary child block and the lower boundary child block unchanged, and calculate the boundary range adjusted second child node coordinates of the upper boundary child block and the lower boundary child block based on the deleted child block and the first child node coordinates of the upper boundary child block and the lower boundary child block, respectively.

In some embodiments, the deleting a child block in the target content block includes: deleting a child block between the upper boundary child block and the lower boundary child block; and
the second obtaining module 15 is further configured to: keep the upper boundary child block and the lower boundary child block unchanged, determine the first child node coordinates of the upper boundary child block as the boundary range adjusted second child node coordinates of the upper boundary child block, and reduce the first child node coordinates of the lower boundary child block based on the deleted child block to generate the boundary range adjusted second child node coordinates of the lower boundary child block.

In some embodiments, the deleting a child block in the target content block includes: deleting the upper boundary child block;
the second obtaining module 15 is further configured to: determine an internal child block adjacent to the upper boundary child block or the lower boundary child block as a new upper boundary child block, and calculate the boundary range adjusted second child node coordinates of the new upper boundary child block based on the first child node coordinates of the internal child block adjacent to the upper boundary child block or the lower boundary child block; or the target content block is empty.

In some embodiments, the deleting a child block in the target content block includes: deleting the lower boundary child block;
the second obtaining module 15 is further configured to: determine an internal child block adjacent to the lower boundary child block or the upper boundary child block as a new lower boundary child block, and determine the first child node coordinates of the internal child block adjacent to the lower boundary child block or the upper boundary child block as the boundary range adjusted second child node coordinates of the new lower boundary child block; or the target content block is empty.

In some embodiments, the second obtaining module 15 is further configured to: obtain a second parent node of the boundary range adjusted target content block in the target document; obtain the first child block of the boundary range adjusted target content block under the second parent node as a new upper boundary child block, and obtaining third child node coordinates of the new upper boundary child block; obtain the last child block of the boundary range adjusted target content block under the second parent node as a new lower boundary child block, and obtaining third child node coordinates of the new lower boundary child block; and determine the second position range based on the second parent node and the third child node coordinates of the new upper boundary child block and the new lower boundary child block.

In some embodiments, the target content block has a reference relationship with an associated content block in an associated document includes:
the associated content block referencing the target content block in the target document; or the target content block referencing the associated content block in the associated document.

In some embodiments, after the obtaining a second position range of the boundary range adjusted target content block in the target document, the method further includes: sending the second position range to the associated document, to cause the associated document to redisplay the associated content block in the associated document based on the second position range.

For ease of description, the above apparatus is described above by dividing functions into various modules. Certainly, when implementing the present disclosure, the functions of the modules may be implemented in one or more software and/or hardware.

The apparatus in the foregoing embodiments is configured to implement the corresponding service orchestration method in any of the foregoing embodiments, and has beneficial effects of the corresponding method embodiment, which are not described herein again.

Based on the same inventive concept, corresponding to the method in any of the foregoing embodiments, the present disclosure further provides a non-transitory computer-readable storage medium storing computer instructions, where the computer instructions are configured to enable the computer to perform the method according to any of the foregoing embodiments.

The computer-readable medium in these embodiments includes a permanent and non-permanent, removable and non-removable medium, and information may be stored by any method or technology. The information may be computer-readable instructions, a data structure, a program module, or other data. Examples of the computer storage medium include, but are not limited to, phase change memory (PRAM), static random access memory (SRAM), dynamic random access memory (DRAM), another type of random access memory (RAM), read-only memory (ROM), electrically erasable programmable read-only memory (EEPROM), flash memory or other memory technologies, read-only compact discs (CD-ROM), digital versatile discs (DVD) or other optical storage, magnetic cassettes, magnetic tape, magnetic disk storage or other magnetic storage devices, or any other non-transmission medium, which may be used to store information accessible by a computing device.

The computer instructions stored in the storage medium in the foregoing embodiments are configured to enable the computer to perform the method according to any of the foregoing embodiments, and have beneficial effects of the corresponding method embodiment, which are not described herein again.

Based on the same inventive concept, corresponding to the method in any of the foregoing embodiments, the present disclosure further provides a computer program product including a computer program. In some embodiments, the computer program is executable by one or more processors to enable the processors to perform the method. A processor that executes a corresponding step may belong to a corresponding execution subject corresponding to each step in each embodiment of the method.

The computer program product in the foregoing embodiments is configured to enable the processor to perform the method according to any of the foregoing embodiments, and has beneficial effects of the corresponding method embodiment, which are not described herein again.

A person of ordinary skill in the art should understand that the discussions of any of the foregoing embodiments are exemplary only, and are not intended to imply that the scope of the present disclosure (including the claims) is limited to these examples; under the idea of the present disclosure, the technical features in the foregoing embodiments or different embodiments may also be combined, and steps may be implemented in any order, and there are many other variations of different aspects of the embodiments of the present disclosure as described above, which are not provided in the details for the sake of brevity.

In addition, to simplify the description and discussion, and so as not to make the embodiments of the present disclosure difficult to understand, well-known power/ground connections to integrated circuit (IC) chips and other components may be shown or not shown in the provided drawings. Further, the apparatus may be shown in the form of a block diagram in order to avoid making the embodiments of the present disclosure difficult to understand, and this is also contemplated in view of the fact that details of the implementation of the block diagram apparatus are highly dependent on the platform on which the embodiments of the present disclosure are to be implemented (that is, these details should be completely within the understanding of those skilled in the art). When specific details (for example, a circuit) are set forth in order to describe the exemplary embodiments of the present disclosure, it will be apparent to those skilled in the art that the embodiments of the present disclosure may be implemented without these specific details or with variations of these specific details. Therefore, the descriptions should be considered as illustrative instead of restrictive.

Although the present disclosure has been described in conjunction with specific embodiments of the present disclosure, many alternatives, modifications, and variations of these embodiments will be apparent to those of ordinary skill in the art from the foregoing description. For example, other memory architectures (for example, dynamic RAM (DRAM)) may use the embodiments discussed herein.

The embodiments of the present disclosure are intended to cover all such alternatives, modifications, and variations falling within the broad scope of the appended claims. Therefore, any omissions, modifications, equivalent replacements, improvements, etc. made within the spirit and principle of the embodiments of the present disclosure shall be included within the protection scope of the present disclosure.

1. A document processing method, comprising:
determining a target content block in a target document, wherein the target content block has a reference relationship with an associated content block in an associated document;
obtaining a first position range of the target content block in the target document;
in response to receiving an operation of adjusting a boundary range of the target content block, obtaining a second position range of the boundary range adjusted target content block in the target document; and
displaying, in the target document, the boundary range adjusted target content block based on the second position range.

2. The method according to claim 1, wherein the target document further comprises a reference identification corresponding to the target content block; and the method further comprises:
in response to receiving a trigger operation for the reference identification, displaying a first window in the target document, wherein the first window comprises user reference information that references the target content block.

3. The method according to claim 2, wherein the user reference information comprises a reference user name, a reference time, and link information of an associated document; or
wherein the first window comprises at least one category label, and the method further comprises, after the first window is displayed in the target document:
in response to receiving a trigger operation for a target category label in the at least one category label, displaying, in the first window, a sub-window page corresponding to the target category label, wherein the sub-window page displays user reference information corresponding to the target category label,
wherein the category label comprises at least one of all user reference information, current user reference information, and other user reference information, and the current user reference information is reference information of an owner user of the target document; or
wherein the first window further comprises a first control, and the method further comprises:
in response to the boundary range of the target content block being adjusted, in a case that the first control is in a triggered state, adjusting a boundary range of the associated content block in the associated document accordingly.

4. (canceled)

5. The method according to claim 1, further comprising:
determining whether a current user is a user to whom the target content block belongs, wherein the owner user of the target document is a user having management permission or edit permission for the target content block;
in response to the current user being the owner user of the target document, adjusting the boundary range of the target content block based on an operation of adjusting the boundary range of the target content block; and
in response to the current user not being the owner user of the target document, rejecting the adjustment of the boundary range of the target content block.

6. (canceled)

7. The method according to claim 3, wherein the first control is in a one-to-one correspondence with the user reference information; or
in response to receiving a trigger operation for the first control, keeping the reference identification in a highlighted state.

8. (canceled)

9. The method according to claim 1, wherein the target content block comprises at least one child block, each child block comprises one row or one column in the target content block, and the child block of the target content block comprise an upper boundary child block and a lower boundary child block; and
adjusting the boundary range of the target content block comprises: inserting or deleting a child block in the target content block.

10. The method according to claim 9, wherein inserting the child block in the target content block comprises: inserting a non-adjacent child block before the upper boundary child block or after the lower boundary child block; and
obtaining the second position range of the boundary range adjusted target content block in the target document comprises: determining the first position range of the target content block in the target document as the second position range of the boundary range adjusted target content block in the target document, or
wherein inserting the child block in the target content block comprises: inserting the child block between the upper boundary child block and the lower boundary child block; and
obtaining the second position range of the boundary range adjusted target content block in the target document comprises: determining the second position range based on a boundary position of the upper boundary child block and a boundary position of the lower boundary child block after the child block is added, or
wherein inserting the child block in the target content block comprises: inserting an adjacent child block before the upper boundary child block and declaring the adjacent child block as a non-changeable boundary; and
obtaining the second position range of the boundary range adjusted target content block in the target document comprises: determining the second position range based on a boundary position of the upper boundary child block after the child block is added and a boundary position of the lower boundary child block, or
wherein inserting the child block in the target content block comprises: inserting an adjacent child block before the upper boundary child block and declaring the adjacent child block as a changeable boundary; and
obtaining the second position range of the boundary range adjusted target content block in the target document comprises: determining the second position range based on a boundary position of the inserted child block and a boundary position of the lower boundary child block after the child block is inserted, or
wherein inserting the child block in the target content block comprises: inserting an adjacent child block after the lower boundary child block and declaring the adjacent child block as a non-changeable boundary; and
obtaining the second position range of the boundary range adjusted target content block in the target document comprises: determining the second position range based on a boundary position of the upper boundary child block and a boundary position of the lower boundary child block, or
wherein inserting the child block in the target content block comprises: inserting an adjacent child block after the lower boundary child block and declaring the adjacent child block as a changeable boundary; and
obtaining the second position range of the boundary range adjusted target content block in the target document comprises: determining the second position range based on a boundary position of the upper boundary child block and a boundary position of the lower boundary child block after the child block is inserted, or
wherein deleting the child block in the target content block comprises: deleting the child block before the upper boundary child block or after the lower boundary child block; and
obtaining the second position range of the boundary range adjusted target content block in the target document comprises: determining the first position range of the target content block in the target document as the second position range of the boundary range adjusted target content block in the target document, or
wherein deleting the child block in the target content block comprises: deleting a child block between the upper boundary child block and the lower boundary child block; and
obtaining the second position range of the boundary range adjusted target content block in the target document comprises: determining the second position range based on a boundary position of the upper boundary child block and a boundary position of the lower boundary child block after the child block is deleted, or
wherein deleting the child block in the target content block comprises: deleting the upper boundary child block; and
obtaining the second position range of the boundary range adjusted target content block in the target document comprises: determining the second position range based on a boundary position of an internal child block adjacent to the upper boundary child block and a boundary position of the lower boundary child block; or determining the second position range based on the boundary position of the lower boundary child block; or the target content block is empty, or
wherein deleting the child block in the target content block comprises: deleting the lower boundary child block; and
obtaining the second position range of the boundary range adjusted target content block in the target document comprises: determining the second position range based on a boundary position of the upper boundary child block and a boundary position of an internal child block adjacent to the lower boundary child block; or determining the second position range based on the boundary position of the upper boundary child block; or the target content block is empty.

11. (canceled)

12. (canceled)

13. (canceled)

14. (canceled)

15. (canceled)

16. (canceled)

17. (canceled)

18. (canceled)

19. (canceled)

20. The method according to claim 1, wherein obtaining the first position range of the target content block in the target document comprises:
obtaining a first parent node of the target content block in the target document;
obtaining first child node coordinates of a boundary of the target content block under the first parent node; and
determining the first position range based on the first parent node and the first child node coordinates.

21. The method according to claim 20, wherein the target content block comprises at least one child block, each child block comprises one row or one column in the target content block, and the child block of the target content block comprises an upper boundary child block and a lower boundary child block; and
adjusting the boundary range of the target content block comprises: inserting or deleting a child block in the target content block; and
obtaining the second position range of the boundary range adjusted target content block in the target document comprises:
in response to detecting an operation instruction of inserting or deleting the child block in the target content block, determining a new boundary of the target content block;
determining second child node coordinates of the new boundary of the target content block under the first parent node based on a position of the new boundary of the target content block in the target content block; and
determining the second position range based on the first parent node and the second child node coordinates.

22. The method according to claim 21, wherein inserting the child block in the target content block comprises: inserting a non-adjacent child block before the upper boundary child block or after the lower boundary child block; and
after the operation of inserting the child block in the target content block is performed, determining the new boundary of the target content block, and determining the second child node coordinates of the new boundary of the target content block under the first parent node based on the position of the new boundary of the target content block in the target content block comprises: keeping the upper boundary child block and the lower boundary child block unchanged, and determining the first child node coordinates of the upper boundary child block and the lower boundary child block as the boundary range adjusted second child node coordinates of the upper boundary child block and the lower boundary child block, respectively, or
wherein inserting the child block in the target content block comprises: inserting a child block between the upper boundary child block and the lower boundary child block; and
after the operation of inserting the child block in the target content block is performed, determining the new boundary of the target content block, and determining the second child node coordinates of the new boundary of the target content block under the first parent node based on the position of the new boundary of the target content block in the target content block comprises: keeping the upper boundary child block and the lower boundary child block unchanged, determining the first child node coordinates of the upper boundary child block as the boundary range adjusted second child node coordinates of the upper boundary child block, and increasing the first child node coordinates of the lower boundary child block based on the inserted child block to generate the boundary range adjusted second child node coordinates of the lower boundary child block, or
wherein inserting the child block in the target content block comprises: inserting an adjacent child block before the upper boundary child block and declaring the adjacent child block as a non-changeable boundary; and
after the operation of inserting the child block in the target content block is performed, determining the new boundary of the target content block, and determining the second child node coordinates of the new boundary of the target content block under the first parent node based on the position of the new boundary of the target content block in the target content block comprises: keeping the upper boundary child block unchanged, and increasing the first child node coordinates of the upper boundary child block and the lower boundary child block based on the inserted child block to generate the boundary range adjusted second child node coordinates of the upper boundary child block and the lower boundary child block, or
wherein inserting the child block in the target content block comprises: inserting an adjacent child block before the upper boundary child block and declaring the adjacent child block as a changeable boundary; and
after the operation of inserting the child block in the target content block is performed, determining the new boundary of the target content block, and determining the second child node coordinates of the new boundary of the target content block under the first parent node based on the position of the new boundary of the target content block in the target content block comprises: determining the inserted child block as a new upper boundary child block of the target content block, determining the second child node coordinates of the new upper boundary child block based on a position of the inserted child block in the target content block, and increasing the first child node coordinates of the lower boundary child block based on the inserted child block to generate the boundary range adjusted second child node coordinates of the lower boundary child block, or
wherein inserting the child block in the target content block comprises: inserting an adjacent child block after the lower boundary child block and declaring the adjacent child block as a non-changeable boundary; and
after the operation of inserting the child block in the target content block is performed, determining the new boundary of the target content block, and determining the second child node coordinates of the new boundary of the target content block under the first parent node based on the position of the new boundary of the target content block in the target content block comprises: determining the first child node coordinates of the upper boundary child block and the lower boundary child block as the boundary range adjusted second child node coordinates of the upper boundary child block and the lower boundary child block, respectively.

23. (canceled)

24. (canceled)

25. (canceled)

26. (canceled)

27. The method according to claim 21, wherein inserting the child block in the target content block comprises: inserting an adjacent child block after the lower boundary child block and declaring the adjacent child block as a changeable boundary; and
after the operation of inserting the child block in the target content block is performed, determining the new boundary of the target content block, and determining the second child node coordinates of the new boundary of the target content block under the first parent node based on the position of the new boundary of the target content block in the target content block comprises: determining the first child node coordinates of the upper boundary child block as the boundary range adjusted second child node coordinates of the upper boundary child block, determining the inserted child block as a new lower boundary child block of the target content block, and determining the second child node coordinates of the new lower boundary child block based on a position of the inserted child block in the target content block.

28. The method according to claim 21, wherein deleting the child block in the target content block comprises: deleting the child block before the upper boundary child block or after the lower boundary child block; and
after the operation of inserting the child block in the target content block is performed, determining the new boundary of the target content block, and determining the second child node coordinates of the new boundary of the target content block under the first parent node based on the position of the new boundary of the target content block in the target content block comprises: keeping the upper boundary child block and the lower boundary child block unchanged, and calculating the boundary range adjusted second child node coordinates of the upper boundary child block and the lower boundary child block based on the deleted child block and the first child node coordinates of the upper boundary child block and the lower boundary child block, respectively.

29. The method according to claim 21, wherein deleting the child block in the target content block comprises: deleting a child block between the upper boundary child block and the lower boundary child block; and
after the operation of inserting the child block in the target content block is performed, determining the new boundary of the target content block, and determining the second child node coordinates of the new boundary of the target content block under the first parent node based on the position of the new boundary of the target content block in the target content block comprises: keeping the upper boundary child block and the lower boundary child block unchanged, determining the first child node coordinates of the upper boundary child block as the boundary range adjusted second child node coordinates of the upper boundary child block, and reducing the first child node coordinates of the lower boundary child block based on the deleted child block to generate the boundary range adjusted second child node coordinates of the lower boundary child block.

30. The method according to claim 21, wherein deleting the child block in the target content block comprises: deleting the upper boundary child block; and
after the operation of inserting the child block in the target content block is performed, determining the new boundary of the target content block, and determining the second child node coordinates of the new boundary of the target content block under the first parent node based on the position of the new boundary of the target content block in the target content block comprises: determining an internal child block adjacent to the upper boundary child block or the lower boundary child block as a new upper boundary child block, and calculating the boundary range adjusted second child node coordinates of the new upper boundary child block based on the first child node coordinates of the internal child block adjacent to the upper boundary child block or the lower boundary child block; or the target content block is empty.

31. The method according to claim 21, wherein deleting the child block in the target content block comprises: deleting the lower boundary child block; and
after the operation of inserting the child block in the target content block is performed, determining the new boundary of the target content block, and determining the second child node coordinates of the new boundary of the target content block under the first parent node based on the position of the new boundary of the target content block in the target content block comprises: determining an internal child block adjacent to the lower boundary child block or the upper boundary child block as a new lower boundary child block, and determining the first child node coordinates of the internal child block adjacent to the lower boundary child block or the upper boundary child block as the boundary range adjusted second child node coordinates of the new lower boundary child block; or the target content block is empty.

32. The method according to claim 20, wherein obtaining the second position range of the boundary range adjusted target content block in the target document comprises:
obtaining a second parent node of the boundary range adjusted target content block in the target document;
obtaining the first child block of the boundary range adjusted target content block under the second parent node as a new upper boundary child block, and obtaining third child node coordinates of the new upper boundary child block;
obtaining the last child block of the boundary range adjusted target content block under the second parent node as a new lower boundary child block, and obtaining third child node coordinates of the new lower boundary child block; and
determining the second position range based on the second parent node and the third child node coordinates of the new upper boundary child block and the new lower boundary child block.

33. The method according to claim 1, wherein the target content block having a reference relationship with an associated content block in an associated document comprises:
the associated content block referencing the target content block in the target document; or
the target content block referencing the associated content block in the associated document.

34. The method according to claim 1, wherein the method further comprises, after obtaining the second position range of the boundary range adjusted target content block in the target document:
sending the second position range to the associated document, to cause the associated document to redisplay the associated content block in the associated document based on the second position range.

35. (canceled)

36. An electronic device, comprising a memory, a processor, and a computer program stored on the memory and executable on the processor, wherein the computer program, when executed by the processor, causes the device to:
determine a target content block in a target document, wherein the target content block has a reference relationship with an associated content block in an associated document;
obtain a first position range of the target content block in the target document;
in response to receiving an operation of adjusting a boundary range of the target content block, obtain a second position range of the boundary range adjusted target content block in the target document; and
display, in the target document, the boundary range adjusted target content block based on the second position range.

37. A non-transitory computer-readable storage medium storing computer instructions, wherein the computer instructions are configured to cause the computer to:
determine a target content block in a target document, wherein the target content block has a reference relationship with an associated content block in an associated document;
obtain a first position range of the target content block in the target document;
in response to receiving an operation of adjusting a boundary range of the target content block, obtain a second position range of the boundary range adjusted target content block in the target document; and
display, in the target document, the boundary range adjusted target content block based on the second position range.

38. (canceled)
